(19) United States
(12) Patent Application Publication
(10) Pub. No.: US 2003/0164891 A1
(43) Pub. Date: Sep. 4, 2003

(54) Solidstate image-taking apparatus and laminated chip for use therewith

(76) Inventor: Kazuo Akimoto, Chiba-ken (JP)

Correspondence Address: ADAMS & WILKS, 31st Floor, 50 Broadway, New York, NY, 10004, US

(21) Appl. No.: 10/370,979

(22) Filed: Feb. 20, 2003

(30) Foreign Application Priority Data
Feb. 21, 2002 (JP) 2002-044947

(51) Int. Cl. H04N 5/225

(52) U.S. Cl. 348/340

(57) ABSTRACT

A solidstate image-taking apparatus has an optical filter and a protective plate combined into a single, integrated structure adhered directly to a solidstate image-taking element, thereby reducing the overall size of the image-taking apparatus. The protective plate may itself be the optical filter, or the optical filter may be an infrared cutout filter, a reflection preventing filter or a low pass filter which is adhered to the protective plate. In the case where the protective plate serves as the optical filter, one face of the protective plate may be provided with a reflection preventing coating layer and the other face thereof may be provided with an infrared cutout coating layer.

### BACKGROUND OF THE INVENTION

1. Field of the Invention

The present invention relates to a solidstate image-taking apparatus and to a laminated chip for use therewith.

2. Description of Related Art

A solidstate image-taking apparatus of a related art is disclosed in, for example, JP-A-2001-36777. As shown by FIG. 9, such an apparatus comprises a window portion 90a provided in a circuit board 90, and a solidstate image-taking element 91 mounted to one face of the circuit board 90 with a light-receiving face of the solidstate image-taking element 91 opposed to the window portion 90a. An infrared cutout filter 92 is attached to the opposite face of the circuit board 90. A lens holder 94 integrated with a lens 93 is attached to the circuit board 90 so as to cover the infrared cutout filter 92 by means of guide pins 94a extending through the board 90.

Since the infrared cutout filter 92 is a separate member, the number of parts is increased, and the step of attaching the infrared cutout filter 92 is also needed and increases the cost of manufacture. Further, since the infrared cutout filter 92 is a separate member, it must have some minimum degree of thickness and the space required to accommodate the infrared cutout filter 92 is disadvantageous in downsizing the solidstate image-taking apparatus.

The present invention has been devised to overcome the foregoing disadvantages, and a principal object of the present invention is to provide a solidstate image-taking apparatus in which an optical filter and a protective plate are combined into a single, integrated structure that is adhered directly to a solidstate image-taking element, thereby reducing the overall size of the image-taking apparatus.

Another object of the present invention is to provide a laminated chip for use with a solidstate image-taking apparatus, wherein the laminated chip comprises a laminated structure having a lower protective plate, a solidstate image-taking element, such as a CCD, adhered to the lower protective plate, and a combined optical filter and protective plate adhered to the solidstate image-taking element.

According to other objects of the present invention, the protective plate may itself be the optical filter, or the optical filter may be an infrared cutout filter, a reflection preventing filter or a low pass filter which is adhered to the protective plate. In the case where the protective plate serves as the optical filter, one face of the protective plate may be provided with a reflection preventing coating layer and the other face thereof may be provided with an infrared cutout coating layer.

The above objects and advantages of the present invention, as well as others, will become apparent to one ordinarily skilled in the art upon a reading of the following detailed description of the present invention in conjunction with the accompanying drawings.

### BRIEF DESCRIPTION OF THE DRAWINGS

FIG. 1 is a sectional view of a camera for a portable apparatus to which the invention is applied;

FIG. 2 is a top plan view showing a state of bringing a laminated chip into contact with a holder;

FIG. 3 is a sectional view of a laminated chip according to one embodiment of the present invention;

FIG. 4 is a sectional view of a laminated chip according to a second embodiment of the present invention;

FIG. 5 is a sectional view of a laminated chip according to a third embodiment of the present invention;

FIG. 6 is a sectional view of a laminated chip according to a fourth embodiment of the present invention;

FIG. 7 is a sectional view of a laminated chip according to a fifth embodiment of the present invention;

FIG. 8 is a sectional view of a laminated chip according to a sixth embodiment of the present invention; and

FIG. 9 is a sectional view of a laminated chip of a related art.

### DETAILED DESCRIPTION OF THE INVENTION

Several embodiments of the invention will be described hereinbelow with reference to the drawings.

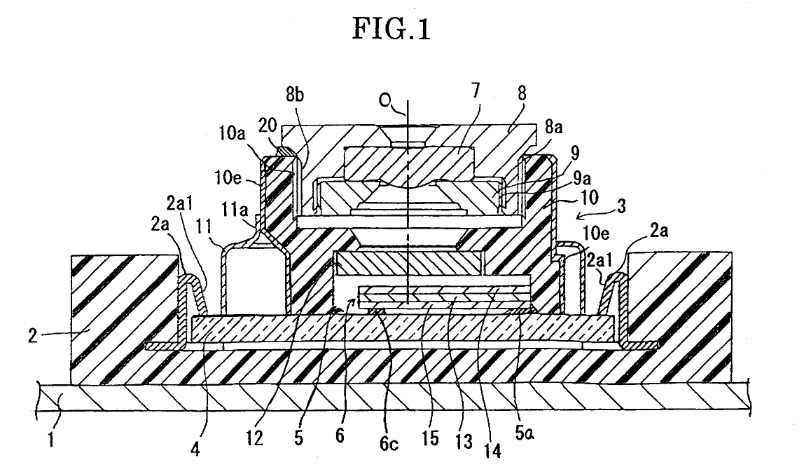

FIG. 1 is an overall view of a solidstate image-taking apparatus in accordance with one embodiment of the invention. A mother board 1 is provided with circuitry or the like for controlling an apparatus main body of a portable apparatus, such as a telephone or the like. A socket 2 formed of a plastic material is connected to the mother board 1 and has conductors (not shown) in electrical contact with conductors (not shown) on the mother board 1. The socket 2 has a locking portion 2a for locking a circuit board 4 for a camera at the inside thereof, and the circuit board 4 is locked by a claw portion 2a1 provided at the locking portion 2a. When the circuit board 4 is locked by the socket 2, a connection terminal (not shown) provided at the socket 2 and a connection terminal (not shown) provided at the circuit board 4 are maintained in electrical contact to thereby enable image-taking information to be transmitted to the mother board 1.

An upper face (the face on the upper side of the drawing) of the circuit board 4 has a laminated chip 6 (described in detail hereinafter) mounted thereon via a conductive bump 6c and also has mounted thereon a lens holder 3 of cylindrical shape which surrounds the laminated chip 6. A lower face of the circuit board 4 is provided with ICs (integrated circuits) for controlling a solidstate image-taking element of a DSP (digital signal processor) (not shown), including a signal processing IC of the laminated chip 6 and a timing generator IC for generating various drive timings of the laminated chip 6.

The lens holder 3 comprises a first holder 10 and a second holer 8. The second holder 8 preferably has a cylindrical shape, and an inner periphery of a lower portion of the second holder is provided with a female screw portion 8a. Another lens holder 9 has a male screw portion 9a at an outer periphery thereof, and the male screw portion 9a is detachably screwed or threaded into the female screw portion 8a to thereby fix a lens 7 between the second holder 8 and the lens holder 9. An outer periphery of a lower portion of the second holder 8 is provided with a male screw portion 8b which is screwed or threaded into a female screw portion 10a of the first holder 10 to thereby fix the second holder 8 to the first holder 10. The distance between the laminated chip 6 and the lens 7 along an optical axis O of the lens 7 is finely adjusted by screwing the second holder 8 into or out of the first holder 10 to bring the lens 7 to an in-focus position relative to the laminated chip 6 and thereafter, the second holder 8 is fixed to the first holder 10 by an adhering agent 20 to maintain the in-focus state.

The first holder 10 is formed in a cylindrical shape from a plastic material, and an outer periphery of the first holder 10 is provided with a metal film 10e by plating or vapor deposition for shielding electromagnetic waves. Further, a shield case 11 formed of a metal, such as aluminum or the like, is provided on the circuit board 4 for shielding electromagnetic waves. A contact piece 11a projects from a portion of the shield case 11, and the contact piece 11a is electrically connected to the metal film 10e by being brought into contact with the metal film 10e at the outer periphery of the first holder 10.

The first holder 10 is mounted to the circuit board 4. An adhering agent 5 for adhering the first holder 10 and the circuit board 4 is interposed therebetween over the entire bottom edge of the first holder 10. A portion of the adhering agent 5 extends radically inwardly, as shown at 5a, between the underside of the laminated chip 6 and the upper face of the circuit board 4 and functions to fix the first holder 10 as well as to reinforce mounting of the laminated chip 6 to the circuit board 4. That is, mounting of the laminated chip 6 to the circuit board 4 is reinforced by the adhering agent 5 to thereby prevent the laminated chip 6 from being detached from the board 4 even when an external force is applied thereto, such as would occur by dropping or banging the portable apparatus.

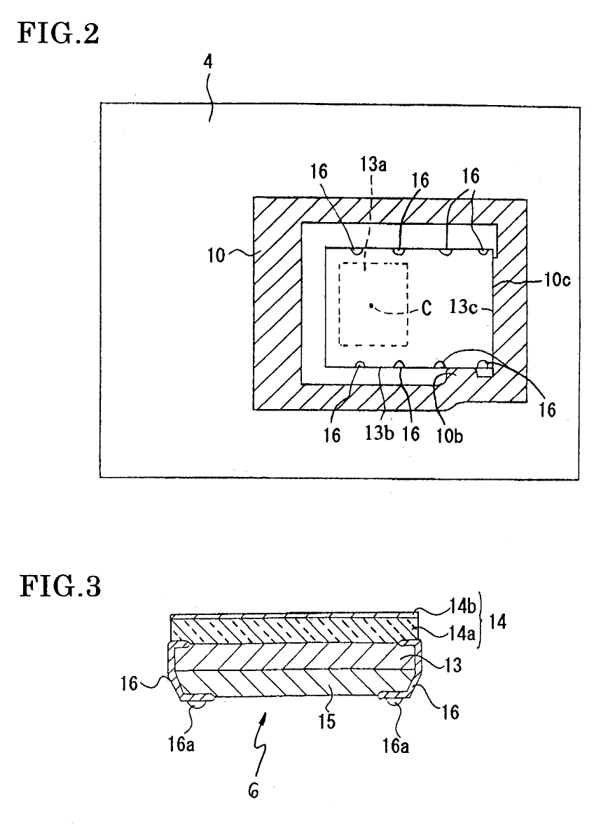

As shown in FIG. 2, projections 10b, 10c provided at the inner periphery of the first holder 10 are brought into contact with two sides 13b, 13c contiguous to each other of a solidstate image-taking element 13 of the laminated chip 6 which is mounted to the circuit board 4. In this manner, the first holder 10 and the solidstate image-taking element 13 are accurately positioned relative to one another so that the optical axis O of the lens 7 coincides with the center C of a light-receiving face 13a of the solidstate image-taking element 13. The positional relationship between the outer peripheral sides of the solidstate image-taking element 13 and the light-receiving face 13a is accurately determined to ensure that the optical axis O of the lens 7 accurately coincides with the center C of the light-receiving face 13a.

One embodiment of the laminated chip 6 will now be described with reference to FIG. 3. As shown by FIG. 3, the laminated chip 6 comprises an infrared cutout filter 14 serving as a protective plate of the solidstate image-taking element 13 as well as an optical filter for preventing transmission of infrared rays by either reflecting or absorbing infrared radiation. The infrared cutout filter 14 is fixedly adhered by bonding or the like to a front face of the solidstate image-taking element 13, which may be a CCD, CMOS or the like. The infrared cutout filter 14 is formed by providing an infrared cutout coating layer 14b on an upper face of a glass protective plate 14a by vapor deposition or ion plating. The infrared cutout coating layer 14 preferably comprises a plurality of alternating layers of silicon oxide and titanium oxide laminated together to form a laminated coating layer 14. Thus the infrared cutout layer 14b and the protective plate 14a are combined into a single, integrated structure that is adhered directly to the front face of the solidstate image-taking element 13. A transparent cover glass 15 constituting a protective plate is fixedly adhered by bonding or the like to a rear face of the solidstate image-taking element 13. Further, an electrode 16 is provided to extend over the surface of the solidstate image-taking element 13 and over a rear face of the cover glass 15, and the electrode 16 and the circuit board 4 are electrically connected via a conductive bump 16a to thereby enable an image signal of the solidstate image-taking element 13 to be transmitted to other circuit elements.

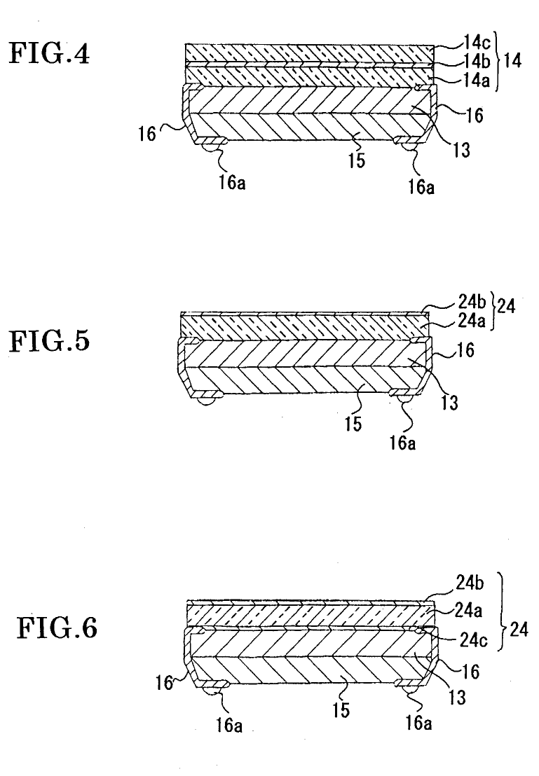

A second embodiment of the laminated chip 6 is shown in FIG. 4. As shown by FIG. 4, the infrared cutout filter 14 has the same construction as that shown in FIG. 3 in which an upper face of the glass protective plate 14a is provided with the infrared cutout coating layer 14b constituted by alternately laminating a plurality of layers (for example, 30 through 40 layers) of silicon oxide and titanium oxide by vapor deposition or ion plating. In this embodiment, a glass protective plate 14c for protecting the infrared cutout coating layer 14b is fixedly attached by bonding or the like to an upper face of the coating layer 14b. The combined infrared cutout layer 14b and protective plates 14a, 14c form a single, integrated structure that is adhered directly to the solidstate image-taking element 13.

FIG. 5 shows a third embodiment of the laminated chip 6. In this embodiment, portions thereof similar to those of the first embodiment are denoted with the same reference characters and an explanation thereof will be omitted. According to this embodiment, an optical filter comprises a reflection preventing filter 24 for preventing a reflective flare or ghost from being transmitted to the surface of the solidstate image-taking element 13. As shown by FIG. 5, the reflection preventing filter 24 is formed by providing a reflection preventing coating layer 24b at an upper face of a glass protective plate 24a by vapor deposition or ion plating. The reflection preventing coating layer 24b is formed of calcium fluoride, magnesium fluoride or the like and has a thickness of about 0.1 μm. The combined reflection preventing layer 24b and protective plate 24a constitute a single, integrated structure which is adhered directly to the solidstate image-taking element 13.

A fourth embodiment of the laminated chip is shown in FIG. 6. As shown by FIG. 6, the reflection preventing filter 24 has the same construction as that shown in FIG. 5 except that in this embodiment two reflection preventing coating layers 24b, 24c are provided at the upper face and a lower face of the glass protective plate 24a by vapor deposition or ion plating. By sandwiching the glass protective plate 24a between the two reflection preventing coating layers 24b, 24c, the reflection prevention effect is further promoted. The combined reflection preventing layers 24b, 24c and protective plate 24a form a single, integrated structure that is adhered directly to the solidstate image-taking element 13.

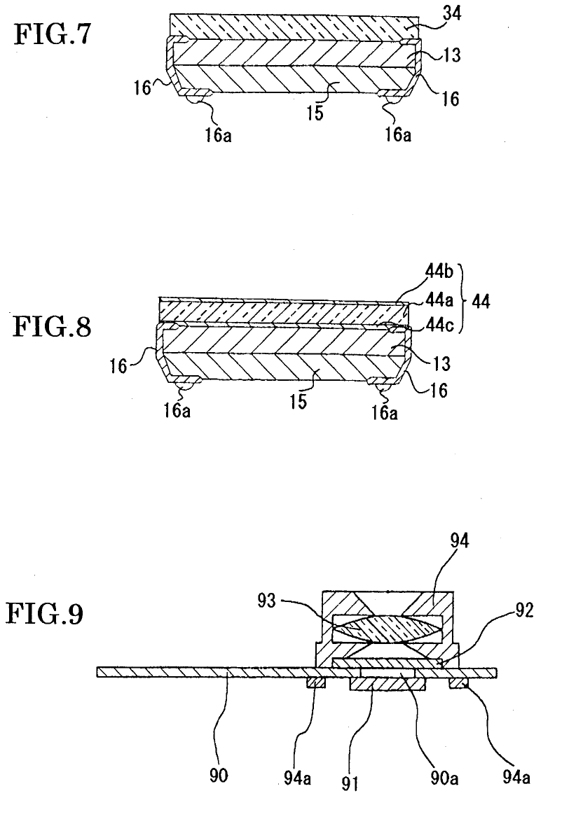

FIG. 7 shows a fifth embodiment of the laminated chip 6. In this embodiment, portions thereof similar to those of the first embodiment are denoted with the same reference characters and an explanation thereof will be omitted. According to this embodiment, the front face of the solidstate image-taking element 13 is bonded to an optical filter comprised of a low pass filter 34 for preventing occurrence of Moiré effects or the like by filtering or cutting out image information finer than a pixel pitch of the solidstate image-taking element 13. The low pass filter 34 preferably comprises a quartz plate which also functions as a protective plate. In this embodiment, the quartz plate 34 constitutes a single structure which functions both as a low pass filter and a protective plate.

FIG. 8 shows a sixth embodiment of the laminated chip 6. In this embodiment, portions thereof similar to whose of the first embodiment are denoted with the same reference characters and an explanation thereof will be omitted. According to this embodiment, a composite function filter 44 is provided as an optical filter. As shown by FIG. 8, an upper face of a low pass filter 44a is provided with a reflection preventing coating layer 44b by vapor deposition or ion plating, and a lower face of the low pass filter 44a is provided with an infrared cutout coating layer 44c by vapor deposition or ion plating. The low pass filter 44a preferably comprises a quartz plate which also functions as a protective plate. The combined optical filter-protective plate 44a, reflection preventing layer 44b and infrared cutout layer 44c constitute a single, integrated structure which is adhered directly to the solidstate image-taking element 13.

As has been explained above, the optical filter comprised of the infrared cutout filter 14 or the like serves also as the protective plate of the solidstate image-taking element 13 and, therefore, the number of parts is reduced and the integrating steps are correspondingly reduced to thereby reduce the manufacturing cost. Further, a space for placement of an exclusive optical filter is not needed and small-sized formation and light-weighted formation of the overall apparatus can be realized. Moreover, the optical length is shortened and downsizing can be realized. Furthermore, since the number of elements for transmitting light is reduced, the image characteristics are not changed or deteriorated as would otherwise occur with a greater number of light-transmitting elements.

What is claimed is:

1. An image-taking apparatus comprising: a circuit board; a solidstate image-taking element electrically connected to circuitry on the circuit board; a combined optical filter and protective plate connected directly to the solidstate image-taking element; and a lens holder having a lens for focusing an image on the solidstate image-taking element.

2. An image-taking apparatus according to claim 1; wherein the combined optical filter and protective plate comprises a protective plate having a lower face adhered to the image-taking element, and a filter layer formed on an upper face of the protective plate.

3. An image-taking apparatus according to claim 2; wherein the filter layer comprises an infrared cutout layer.

4. An image-taking apparatus according to claim 3; wherein the filter layer comprises a lamination of alternating layers of silicon oxide and titanium oxide.

5. An image-taking apparatus according to claim 3; further including another protective plate formed on the filter layer.

6. An image-taking apparatus according to claim 2; wherein the filter layer comprises a reflection preventing layer.

7. An image-taking apparatus according to claim 6; wherein the reflection preventing layer comprises one of a calcium fluoride layer and a magnesium fluoride layer.

8. An image-taking apparatus according to claim 6; wherein the reflection preventing layer has a thickness of about 0.1 μm.

9. An image-taking apparatus according to claim 1; wherein the combined optical filter and protective plate comprises a single plate having the properties of a low pass filter.

10. An image-taking apparatus according to claim 9; wherein the single plate comprises a quartz plate.

11. An image-taking apparatus according to claim 1; wherein the combined optical filter and protective plate comprises a filter layer comprised of a reflection preventing layer formed on the image-taking element, a protective plate having a lower face adhered to the reflection preventing layer, and another filter layer comprised of another reflection preventing layer formed on an upper face of the protective plate.

12. An image-taking apparatus according to claim 11; wherein the protective plate comprises a low pass filter.

13. An image-taking apparatus according to claim 12; wherein the protective plate comprises a quartz plate.

14. A laminated chip for use in an image-taking apparatus, the laminated chip comprising: a laminated structure having a lower protective plate, a solidstate image-taking element adhered to an upper face of the lower protective plate, and a combined optical filter and protective plate adhered to a front face of the image-taking element.

15. A laminated chip according to claim 14; wherein the combined optical filter and protective plate comprises a protective plate having a lower face adhered to the image-taking element, and a filter layer formed on an upper face of the protective plate.

16. A laminated chip according to claim 15; wherein the filter layer comprises an infrared cutout layer.

17. A laminated chip according to claim 16; wherein the filter layer comprises a lamination of alternating layers of silicon oxide and titanium oxide.

18. A laminated chip according to claim 16; further including another protective plate formed on the filter layer.

19. A laminated chip according to claim 15; wherein the filter layer comprises a reflection preventing layer.

20. A laminated chip according to claim 19; wherein the reflection preventing layer comprises one of a calcium fluoride layer and a magnesium fluoride layer.

21. A laminated chip according to claim 19; wherein the reflection preventing layer has a thickness of about 0.1 μm.

22. A laminated chip according to claim 14; wherein the combined optical filter and protective plate comprises a single plate having the property of a low pass filter.

23. A laminated chip according to claim 22; wherein the single plate comprises a quartz plate.

24. A laminated chip according to claim 14; wherein the combined optical filter and protective plate comprises a filter layer comprised of a reflection preventing layer formed ont he image-taking element, a protective plate having a lower face adhered to the reflection preventing layer, and another filter layer comprised of another reflection preventing layer formed on an upper face of the protective plate.

25. A laminated chip according to claim 24; wherein the protective plate comprises a low pass filter.

26. An image-taking apparatus according to claim 25; wherein the protective plate comprises a quartz plate.
